(19) United States
(12) Patent Application Publication
(10) Pub. No.: US 2014/0347023 A1
(43) Pub. Date: Nov. 27, 2014

(54) SEMICONDUCTOR INTEGRATED CIRCUIT

(71) Applicant: ROHM CO., LTD., Kyoto (JP)

(72) Inventor: Ryosuke INAGAKI, Kyoto (JP)

(73) Assignee: ROHM CO., LTD., Kyoto (JP)

(21) Appl. No.: 14/287,528

(22) Filed: May 27, 2014

(30) Foreign Application Priority Data
May 27, 2013 (JP) 2013-111117
May 23, 2014 (JP) 2014-107026

(51) Int. Cl. G05F 1/56

(52) U.S. Cl. CPC G05F 1/56
USPC 323/281

(57) ABSTRACT

A reference power supply is built into a semiconductor integrated circuit, receives an input voltage V_{DD}, and supplies an internal power supply voltage V_{REG} to a second power supply line. The reference power supply comprises (i) a current source which generates a bias current, and (ii) a reference voltage circuit including a Zener diode arranged on a path of the bias current, configured to output a first voltage according to a voltage generated at the Zener diode, which are arranged in series between a first power supply line and a ground line. An emitter-follower or source-follower buffer circuit includes a first transistor having its base/gate receiving the first voltage and its emitter/source connected to the second power supply line. The buffer circuit outputs, as the internal power supply voltage, a voltage generated at the emitter/source of the first transistor.

### BACKGROUND OF THE INVENTION

1. Field of the Invention

The present invention relates to a semiconductor integrated circuit.

2. Description of the Related Art

A semiconductor integrated circuit operates receiving a power supply voltage from an external power supply (e.g., a battery) such as an external battery, DC/DC converter, charge pump circuit, or the like. FIGS. 1A and 1B are block diagrams each showing a typical configuration of a semiconductor integrated circuit. A semiconductor integrated circuit 100r shown in FIG. 1A includes a power supply terminal (VDD terminal), a ground terminal (VSS terminal), power supply lines 102 and 104, and a circuit block 106.

The VSS terminal is connected to the ground line. The power supply voltage V_{DD} is supplied from a battery 200 to the VDD terminal. The power supply lines 102 and 104 are connected to the VDD terminal and the VSS terminal, respectively. The circuit block 106 operates using the power supply voltage V_{DD} across the power supply lines 102 and 104. With such a configuration shown in FIG. 1A, if the voltage V_{DD} from the battery 200 fluctuates, the voltage supplied to the circuit clock 106 also fluctuates.

A semiconductor integrated circuit 100s shown in FIG. 1B further includes a reference power supply 2s, in addition to the configuration of the semiconductor integrated circuit 100r shown in FIG. 1A. The reference power supply 2s receives the power supply voltage V_{DD} at the first power supply line 102, generates an internal power supply voltage V_{REG} stabilized to a certain predetermined level, and supplies the internal power supply voltage V_{REG} thus generated to an internal circuit block 106 via a second power supply line 108. With the semiconductor integrated circuit 100s shown in FIG. 1B, the internal power supply voltage V_{REG} can be maintained at a constant level even if the power supply voltage V_{DD} fluctuates. Thus, such an arrangement allows the circuit block 106 to stably operate.

In recent years, progress is being made in operating electrical appliances, products for in-vehicle use, and the like with a high frequency. If a high-frequency signal is input as noise to a semiconductor integrated circuit, such high-frequency noise becomes a cause of a malfunction of the semiconductor integrated circuit. Thus, such a semiconductor integrated circuit to be mounted on a vehicle is required to pass an electrostatic discharge (ESD) test, an electromagnetic compatibility (EMC) test, and in particular, an electromagnetic susceptibility immunity (EMS) test. The EMS test is required by international standards. Specifically, in the EMS test, judgment is strictly made whether or not such a malfunction occurs in the operation of the semiconductor integrated circuit due to interference waves emitted from an external circuit to the product to be tested. Known examples of such a test include: the DPI (Direct RF Power Injection) method according to the semiconductor integrated circuit EMS standard IEC 62132-4 stipulated by the IEC (International Electrotechnical Commission); and the BCI (Bulk Current Injection) method according to the EMS standard for product use ISO 11452-4 stipulated by the ISO (International Organization for Standardization). With the DPI method, interference wave power having a frequency of 150 kHz to 1 GHz is injected into each terminal of the semiconductor integrated circuit. With the BCL method, interference wave current having a frequency of 1 MHz to 400 MHz is injected into all terminals of the semiconductor integrated circuit. With either method, the operation of the semiconductor integrated circuit is checked while such interference wave power or interference wave current is being injected.

It is very difficult in the design stage to check whether or not the product will pass the EMS test. Thus, there is a need to manufacture a prototype semiconductor integrated circuit, and to execute the EMS test to confirm whether or not the semiconductor integrated circuit actually passes the EMS test. If the prototype semiconductor integrated circuit does not satisfy the requirements of the international standard, the semiconductor integrated circuit must be designed again. Thus, the EMS test has a great effect on the development period and development cost.

In order to design a semiconductor integrated circuit having improved tolerance for high-frequency noise, the present inventors have focused their attention on the reference power supply 2s shown in FIG. 1B. FIGS. 2A through 2D include circuit diagrams showing the reference power supply 2s and diagrams showing simulation results with respect to the reference power supply 2s;

FIG. 2A is a circuit diagram showing a configuration of an LDO (Low Drop Output, which is also referred to as the “linear regulator”) 90, which is generally employed as the reference power supply 2s. The linear regulator 90 includes a reference voltage source 92, a differential amplifier (error amplifier) 94, an output transistor 96, and resistors R11 and R12.

The linear regulator 90 receives the DC power supply voltage V_{DD} supplied to an input line 97, and stabilizes the voltage V_{REG} at an output line 98 to a predetermined level regardless of the power supply voltage V_{DD} and the temperature.

The reference voltage source 92 is configured as a so-called bandgap reference circuit. The reference voltage source 92 outputs a reference voltage V_{BG} which is not dependent on the temperature and the power supply voltage V_{DD}. The output transistor 96 is arranged between the input line 97 and the output line 98. The reference voltage V_{BG} is input to an inverting input terminal (−) of the differential amplifier 94. The output voltage V_{REG} is divided by means of the resistors R11 and R12. The output voltage thus divided is fed back to the non-inverting input terminal (+) of the differential amplifier 94. The differential amplifier 94 amplifies the difference between the reference voltage V_{BG} and the feedback voltage V_{FB}, and supplies the difference thus amplified to a control terminal (base) of the output transistor 96.

The linear regulator 90 performs a feedback operation such that the feedback voltage V_{FB} approaches the reference voltage V_{BG}. As a result, the output voltage V_{REG} is stabilized to a target level represented by the following Expression.

V_{REG}=V_{BG}×(1+R12/R11)

FIG. 2B shows the DC analysis results with respect to the linear regulator 90. The horizontal axis represents the DC voltage V_{DD}. The vertical axis represents the output voltage V_{REG} and the reference voltage V_{BG}, in addition to the DC voltage V_{DD}.

FIGS. 2C and 2D show the simulation results with respect to the temporal waveforms when high-frequency noise having a frequency of 1 MHz and 100 MHz, respectively, is injected into the input line 97. The simulation results are obtained using a typical semiconductor process device model for the transistor elements and the resistor elements.

With the linear regulator 90 shown in FIG. 2A, the high-frequency noise injected into the input line 97 is superimposed on the reference voltage V_{BG} via a parasitic capacitance that occurs at a transistor or the like. On the other hand, two noise components are superimposed on the output voltage V_{REG}: (i) a component obtained by amplifying the fluctuation in the reference voltage V_{BG} with a gain of (1+R12/R11), and (ii) a noise component which reaches the output line 98 from the input line 97 via the output transistor 96 or other paths.

As described above, with the linear regulator 90 shown in FIG. 2A, if high-frequency noise is input to the input line 97, this leads to fluctuation in the output voltage V_{REG}. Such fluctuation in the output voltage V_{REG} can become a cause of a malfunction of the circuit block 106 shown in FIG. 1B.

It should be noted that this problem has not been generally recognized by those skilled in this art.

### SUMMARY OF THE INVENTION

The present invention has been made in order to solve such a problem. Accordingly, it is an exemplary purpose of an embodiment of the present invention to provide a semiconductor integrated circuit having improved tolerance for high-frequency noise.

An embodiment of the present invention relates to a semiconductor integrated circuit. The semiconductor integrated circuit comprises: a power supply terminal coupled to receive a DC input voltage from an external power supply; a ground terminal grounded on the exterior; a first power supply line connected to the power supply terminal; a ground line connected to the ground terminal; a second power supply line; a reference power supply configured to receive the input voltage, and to supply an internal power supply voltage to the second power supply line; and an internal circuit connected to the second power supply line and the ground line, and configured to receive the internal power supply voltage as its operation voltage. The semiconductor integrated circuit is monolithically integrated on a single semiconductor substrate. The reference power supply comprises: a reference voltage circuit comprising: (i) a current source configured to generate a bias current; and (ii) a Zener diode arranged on a path of the bias current, such that they are arranged in series between the first power supply line and the ground line, and configured to output a first voltage that corresponds to a voltage (Zener voltage) generated at the Zener diode; and an emitter/source follower buffer circuit comprising a first transistor having its base/gate receiving the first voltage generated by the reference voltage circuit and its emitter/source connected to the second power supply line, and configured to output, as the internal power supply voltage, a voltage generated at the emitter/source of the first transistor.

Such an embodiment is capable of reducing the effect on the internal power supply voltage of high-frequency noise input to the power supply terminal or the ground terminal. Thus, such an arrangement prevents a malfunction of the circuit.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1A and 1B are block diagrams each showing a typical configuration of a semiconductor integrated circuit;

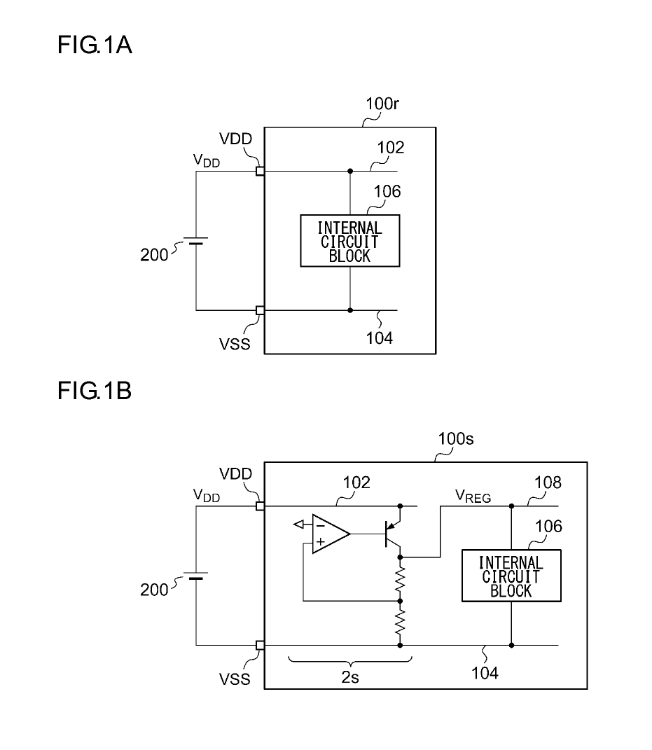

FIGS. 2A through 2D include circuit diagrams showing a reference power supply and diagrams showing simulation results with respect to the reference power supply;

FIG. 3 is a circuit diagram showing a configuration of a semiconductor integrated circuit according to an embodiment;

FIGS. 4A through 4C are diagrams each showing simulation results with respect to the reference power supply shown in FIG. 3;

FIGS. 5A through 5F are circuit diagrams each showing a modification of the reference power supply;

FIGS. 6A and 6B are circuit diagrams each showing another modification of the reference power supply;

FIGS. 7A through 7C are circuit diagrams each showing a modification of the reference power supply; and

FIG. 8 is a block diagram showing a vehicle including a reference power supply.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is connected to the member B” includes a state in which the member A is indirectly connected to the member B via another member that does not affect the electric connection therebetween, in addition to a state in which the member A is physically and directly connected to the member B.

Similarly, the state represented by the phrase “the member C is provided between the member A and the member B” includes a state in which the member A is indirectly connected to the member C, or the member B is indirectly connected to the member C via another member that does not affect the electric connection therebetween, in addition to a state in which the member A is directly connected to the member C, or the member B is directly connected to the member C.

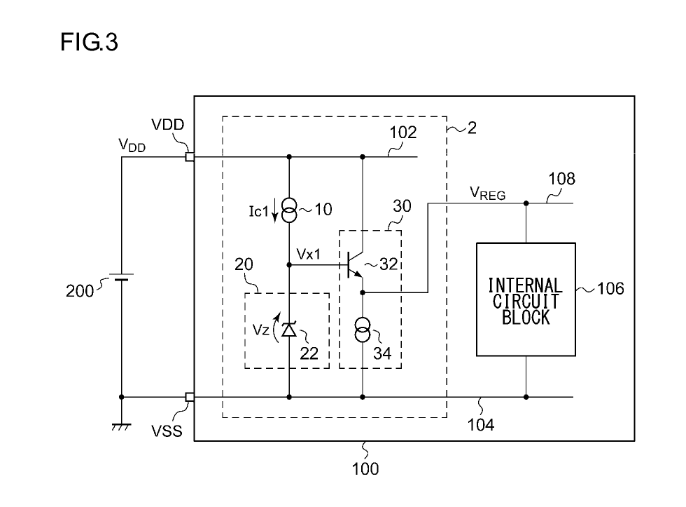

FIG. 3 is a circuit diagram showing a configuration of a semiconductor integrated circuit 100 according to an embodiment. The semiconductor integrated circuit 100 includes a power supply (VDD) terminal, a ground (VSS) terminal, a first power supply line 102, a ground line 104, a second power supply line 108, a circuit block 106, and a reference power supply 2, which are monolithically integrated on a single semiconductor substrate.

Examples of such a “monolithically integrated” arrangement include: an arrangement in which all the circuit components are formed on a semiconductor substrate; and an arrangement in which principal circuit components are monolithically integrated. Also, a part of the circuit components such as resistors and capacitors may be arranged in the form of components external to such a semiconductor substrate in order to adjust the circuit constants.

The DC input voltage V_{DD} is supplied to the VDD terminal from an external power supply 200. The VSS terminal is grounded on the exterior of the semiconductor integrated circuit 100.

The power supply line 102 is connected to the VDD terminal, and the ground line 104 is connected to the VSS terminal.

The reference power supply 2 receives the input voltage V_{DD}, and supplies, to the second power supply line 108, an internal power supply voltage V_{REG} stabilized to a predetermined level.

The reference power supply 2 includes a current source 10, a reference voltage circuit 20, and a buffer circuit 30. The current source 10 and the reference voltage circuit 20 are arranged in series between the first power supply line 102 and the ground line 104.

The current source 10 may be configured as a constant current circuit which generates a bias current Ic1 stabilized to a predetermined current value. Alternatively, the current source 10 may be configured as a resistor. The reference voltage circuit 20 includes a Zener diode 22 arranged on a path of the bias current Ic1. The reference voltage circuit 20 outputs a first voltage Vx1 that corresponds to a voltage (Zener voltage) Vz at the Zener diode 22.

The buffer circuit 30 is configured as an emitter-follower buffer circuit including a first transistor 32 and a load 34. The first transistor 32 is configured as an NPN bipolar transistor. The first transistor 32 receives the first voltage Vx1 from the reference voltage circuit 20 at its base, and its emitter is connected to the second power supply line 108 and the load 34. The load 34 is configured as a current source, for example. Also, the load 32 may be configured as a resistor element, or otherwise a transistor having its base/gate biased as appropriate. The collector of the first transistor 32 is connected to the first power supply line 102. The reference voltage circuit 20 outputs the voltage generated at the emitter of the first transistor 32 as the internal power supply voltage V_{REG}.

The above is the configuration of the semiconductor integrated circuit 100 according to the embodiment. Next, description will be made regarding the characteristics of the reference power supply 2.

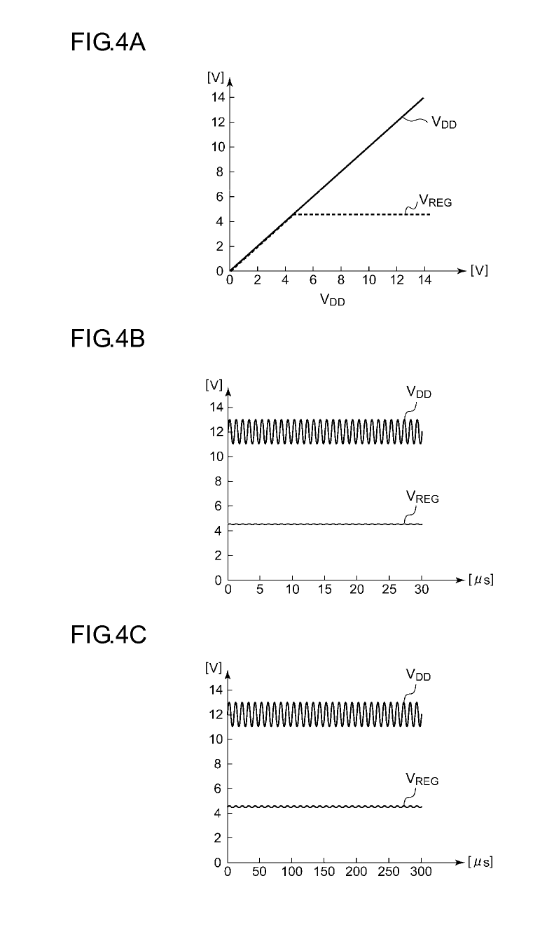

FIGS. 4A through 4C are diagrams each showing the simulation results with respect to the reference power supply 2 shown in FIG. 3. FIG. 4A shows the DC analysis results with respect to the reference power supply 2.

With the reference power supply 2, the first voltage Vx1 is equal to the Zener voltage Vz of the Zener diode 22. With the base-emitter voltage of the first transistor 32 as Vf, the internal power supply voltage V_{REG} configured as the output of the emitter-follower buffer circuit 30 is represented by Vx1−Vf. Thus, the internal power supply voltage V_{REG} is stabilized to V_{REG}=Vz−Vf. Here, Vz and Vf each represent a value of a physical property. Thus, as shown in FIG. 4A, in a case in which the input voltage V_{DD} is raised to a certain level, the internal power supply voltage V_{REG} exhibits a constant value which is independent of the input voltage V_{DD}.

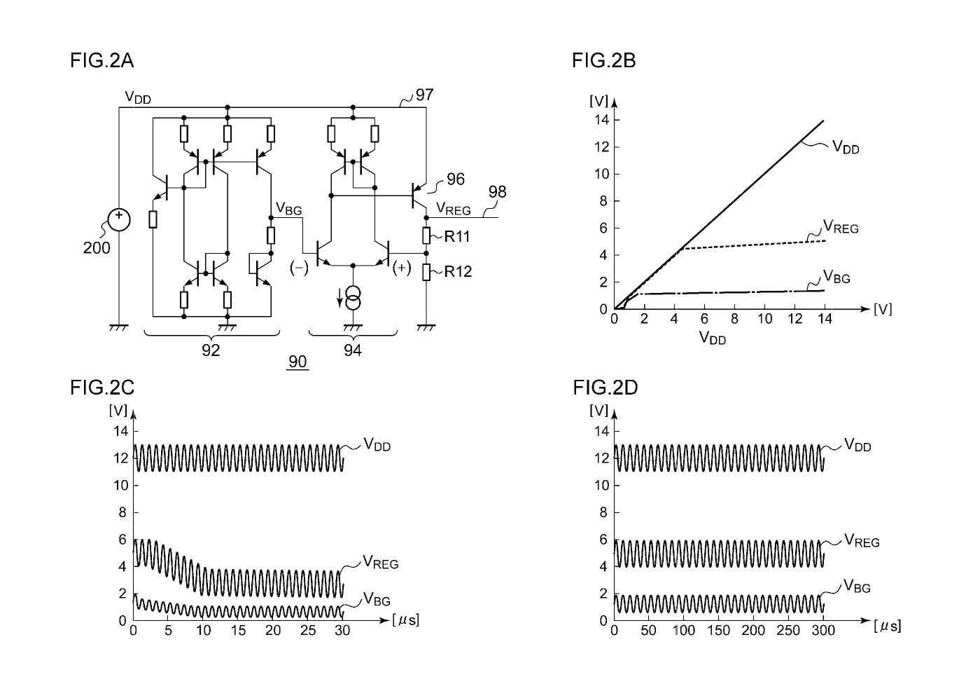

In addition, the number of elements that form the reference power supply 2 shown in FIG. 3 is relatively small, as compared with that of the reference power supply 2s shown in FIG. 2A. This provides advantages of a reduced circuit area, reduced cost, and reduced failure ratio.

FIGS. 4B and 4C show the temporal waveform simulation results when high-frequency noise having a frequency of 1 MHz and 100 MHz, respectively, is injected into the first power supply line 102. In order to provide equivalent conditions to those shown in FIGS. 2C and 2D, the simulation results are obtained using the typical semiconductor process device model for the transistor elements and the resistor elements.

As shown in FIGS. 4B and 4C, with the semiconductor integrated circuit 100 shown in FIG. 3, the noise components superimposed on the internal power supply voltage V_{REG} are greatly reduced, as compared with those shown in FIGS. 2C and 2D, thereby providing improved EMS characteristics.

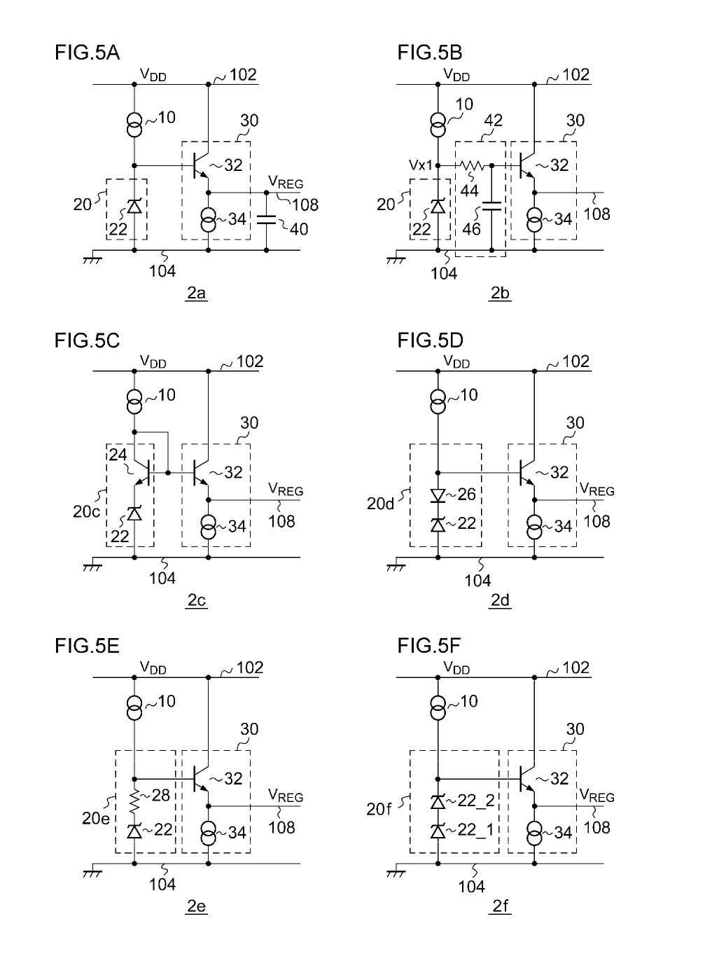

Next, description will be made regarding a modification of the reference power supply 2. FIGS. 5A through 5F are circuit diagrams each showing a modification of the reference power supply 2.

A reference power supply 2a shown in FIG. 5A further includes a first capacitor 40, in addition to the configuration of the reference power supply 2 shown in FIG. 3. The first capacitor 40 is arranged between the second power supply line 108 and the ground line 104. The first capacitor 40 allows the electric potential of the second power supply line 108 to be smoothed, thereby further reducing noise superimposed on the internal power supply voltage V_{REG}. That is to say, such an arrangement provides improved EMS characteristics.

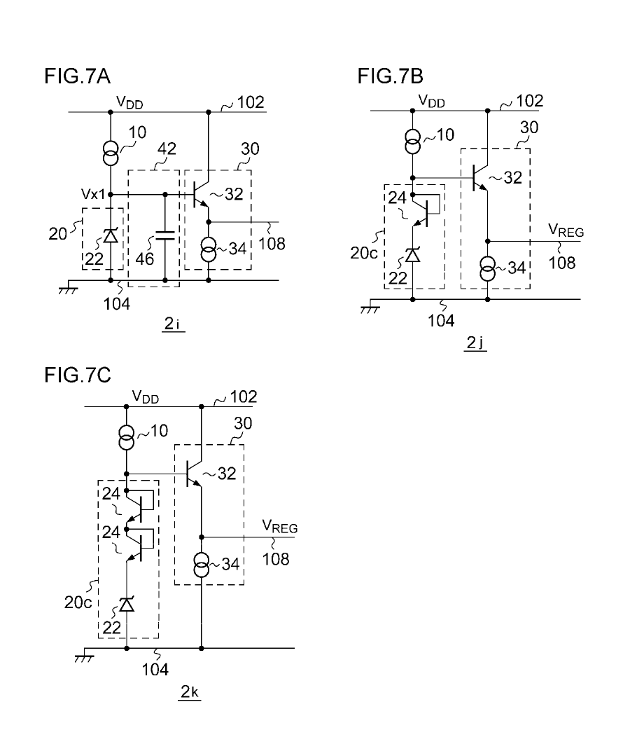

A reference power supply 2b shown in FIG. 5B further includes a low-pass filter 42, in addition to the configuration of the reference power supply 2 shown in FIG. 3. The low-pass filter 42 removes the high-frequency component of the first voltage Vx1, and outputs the first voltage Vx1 thus subjected to low-pass filtering to the base of the first transistor 32. The low-pass filter 42 may be configured as an RC filter including a resistor 44 and a second capacitor 46. Here, the resistor 44 may be omitted. The low-pass filter 42 allows the noise component of the first voltage Vx1 to be removed, thereby further reducing the noise superimposed on the internal power supply voltage V_{REG}. That is to say, such an arrangement provides improved EMS characteristics. FIG. 7A shows a configuration obtained by omitting the resistor 44 shown in FIG. 5B, and including the capacitor 46 arranged between the ground line 104 and a connection node that connects the constant current source 10 and the reference voltage circuit 20. As another modification, a capacitor may be provided to other modifications such that it is arranged between the current source 10 and a connection node that connects the current source 10 and the reference voltage circuit 20. Such a modification may be applied to the modifications described above with reference to FIGS. 5A and 5B, and modifications which will be described later with reference to FIGS. 5C through 5F.

The semiconductor integrated circuit 100 having high noise tolerance is suitable for in-vehicle use.

Also, an arrangement may be made by combining the modification including the capacitor 40 shown in FIG. 5A and the modification including the low-pass filter 42 shown in FIG. 5B.

In a reference power supply 2c shown in FIG. 5C, a reference voltage circuit 20c further includes a second transistor 24 in addition to the Zener diode 22. The second transistor 24 is configured as an NPN bipolar transistor which is the same type as the first transistor 32. The second transistor 24 has its base and its collector connected together, and its emitter connected to the cathode of the Zener diode. The reference voltage circuit 20c outputs, as the first voltage Vx1, the sum total of the collector-emitter voltage of the second transistor 24 and the voltage Vz generated at the Zener diode.

The base-emitter voltage Vf of the second transistor 24 is equal to the base-emitter voltage Vf of the first transistor 32. Thus, the output voltage V_{REG} of the reference power supply 2c is represented by the following Expression.

V_{REG}=Vx1−Vf=(Vz+Vf)−Vf=Vz

That is to say, the base-emitter voltage of the first transistor 32 can be canceled out by means of the base-emitter voltage of the second transistor 24. Typically, the base-emitter voltage Vf has temperature dependence. Thus, with the reference power supply 2 shown in FIG. 3, when the base-emitter voltage Vf changes due to a change in the temperature, this leads to a change in the output voltage V_{REG}. In contrast, with the reference power supply 2c, such an arrangement allows the output voltage V_{REG} to have reduced temperature dependence.

As another modification of the reference power supply 2c shown in FIG. 5C, the second transistor 24 and the Zener diode 22 may mutually exchanged.

In a reference power supply 2d shown in FIG. 5D, the reference voltage circuit 20d further includes a diode 26 connected in series with the Zener diode 22. The diode 26 may be configured as a PN junction diode. With the forward voltage of the diode 26 as Vf, the output voltage of the reference power supply 2d is represented by the following Expression.

V_{REG}=Vx1−Vf=(Vz+Vf)−Vf=Vz.

As shown in FIG. 7B, the diode 26 may be configured using a bipolar transistor. In this case, it can be said that the reference power supply 2d is equivalent to the reference power supply 2c. Also, the Zener diode 22 and the diode 26 may mutually be exchanged. Also, the diode 26 may be configured as N (N represents an integer) diodes. In this case, the internal power supply voltage V_{REG} is represented by the following Expression. The voltage level of the internal power supply voltage V_{REG} can be adjusted according to the number of diodes 26.

V_{REG}=Vx1−Vf=(Vz+N×Vf)−Vf=Vz+(N−1)×Vf

In a reference power supply 2e shown in FIG. 5E, a reference voltage circuit 20e further includes a resistor 28 connected in series with the Zener diode 22. The current source 10 is configured as a constant current source which generates a current Ic1 having a predetermined current value. With the resistance value of the resistor 28 as R1, the first voltage Vx1 is represented by (Vz+Ic1×R1). Thus, the internal power supply voltage V_{REG} is represented by the following Expression.

V_{REG}=Vz+Ic1×R1−Vf

Such a modification allows the voltage level of the internal power supply voltage V_{REG} to be adjusted according to the resistance value R1 and the current value Ic1.

In a reference power supply 2f shown in FIG. 5F, a reference voltage circuit 20f includes N Zener diodes 22_1 through 22_N connected in series. The number N may be determined as desired. FIG. 5F shows an arrangement in which N=2. The internal power supply voltage V_{REG} is represented by the following Expression. The voltage level of the internal power supply voltage V_{REG} can be adjusted according to the number N of Zener diodes 22.

V_{REG}=Vz×N−Vf

Regarding the reference voltage circuits 20 shown in FIGS. 5C and 5D, various combinations may be made with respect to the second transistor 24, the diode 26, and the resistor 28. For example, as shown in FIG. 7C, the second transistor 24 may be configured as two, three, or more stacked transistors.

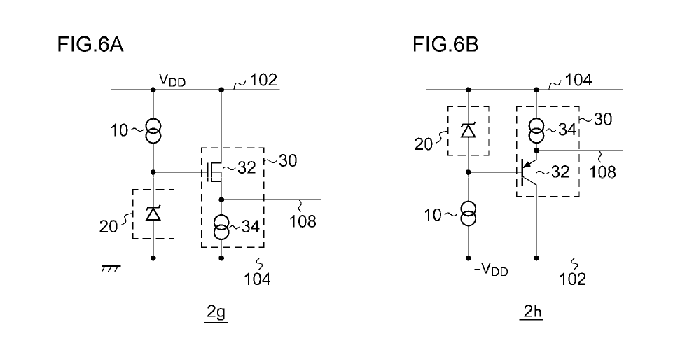

FIGS. 6A and 6B are circuit diagrams each showing yet another modification of the reference power supply 2.

A reference power supply 2g shown in FIG. 6A has the same configuration as that shown in FIG. 3 except that the bipolar transistor configured as the first transistor 32 is replaced with an N-channel MOSFET. In the present modification, the terms “base”, “emitter”, and “collector” described above may be replaced by “gate”, “source”, and “drain”, respectively.

Such replacement of the bipolar transistor with a MOSFET may effectively applied to the modifications shown in FIGS. 5A through 5F. In the modification shown in FIG. 5C, the second transistor 24 may preferably be configured as an N-channel MOSFET which is the same type as the first transistor 32.

In a reference power supply 2h shown in FIG. 6B, each NPN bipolar transistor is replaced with a PNP bipolar transistor. Furthermore, the ground line 104, the first power supply line 102, and each circuit element, are electrically reversed. In particular, such a modification is suitably applicable to a semiconductor integrated circuit 100 configured to receive a negative power supply. Also, such a modification may be applied to the reference power supplies shown in FIGS. 5A through 5F and FIG. 6A.

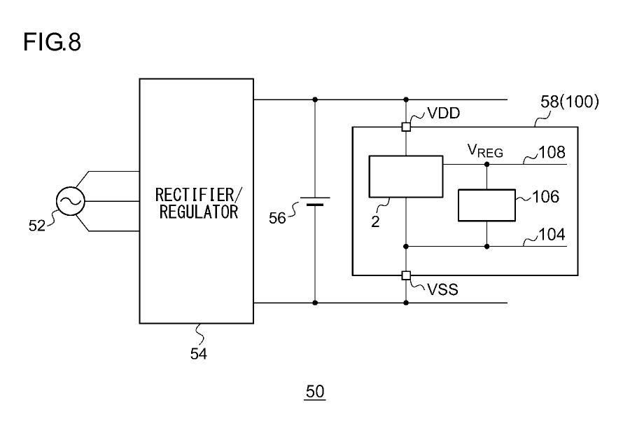

The reference power supply 2 is suitably employed in a vehicle. FIG. 8 is a block diagram showing a vehicle including the reference power supply 2. A vehicle 50 includes an alternator 52, a rectifier/regulator 54, a battery 56, and one or multiple in-vehicle ICs (Integrated Circuits) 58. The alternator 52 generates electric power using the rotation of an engine or otherwise an electric motor as a power source. The rectifier/regulator 54 converts AC electric power generated by the alternator 52 into DC electric power, stabilizes the DC electric power thus converted to a predetermined voltage level, and stores the electric power thus stabilized in the battery 56. The in-vehicle IC 58 operates receiving the battery voltage V_{BAT}. The in-vehicle IC 58 includes the reference power supply 2 described above. Examples of such an in-vehicle IC 58 include a power supply controller, an in-vehicle microcomputer, a control circuit for a headlamp, an engine control IC, a relay control circuit, and the like.

While the preferred embodiments of the present invention have been described using specific terms, such description is for illustrative purposes only, and it is to be understood that changes and variations may be made without departing from the spirit or scope of the appended claims.

What is claimed is:

1. A semiconductor integrated circuit comprising:
a power supply terminal coupled to receive a DC input voltage from an external power supply;
a ground terminal grounded on the exterior;
a first power supply line connected to the power supply terminal;
a ground line connected to the ground terminal;
a second power supply line;
a reference power supply configured to receive the input voltage, and to supply an internal power supply voltage to the second power supply line; and
an internal circuit connected to the second power supply line and the ground line, and configured to receive the internal power supply voltage as its operating voltage, wherein the semiconductor integrated circuit is monolithically integrated on a single semiconductor substrate,
and wherein the reference power supply comprises:
a reference voltage circuit comprising:
(i) a current source configured to generate a bias current; and
(ii) a Zener diode arranged on a path of the bias current, such that they are arranged in series between the first power supply line and the ground line, and configured to output a first voltage that corresponds to a voltage generated at the Zener diode; and
an emitter/source follower buffer circuit comprising a first transistor having its base/gate receiving the first voltage generated by the reference voltage circuit and its emitter/source connected to the second power supply line, and configured to output, as the internal power supply voltage, a voltage generated at the emitter/source of the first transistor.

2. The semiconductor integrated circuit according to claim 1, wherein the reference voltage circuit further comprises a second transistor which is the same type as the first transistor, the second transistor having its base/gate connected to its collector/drain and its emitter/source connected to a cathode of the Zener diode,
and wherein a voltage generated across the second transistor and the Zener diode is output as the first voltage.

3. The semiconductor integrated circuit according to claim 1, wherein the reference voltage circuit further comprises a diode connected in series with the Zener diode.

4. The semiconductor integrated circuit according to claim 1, wherein the reference voltage circuit further comprises a resistor connected in series with the Zener diode,
and wherein the current source is configured as a constant current circuit configured to generate a bias current having a predetermined current value.

5. The semiconductor integrated circuit according to claim 1, wherein the reference voltage circuit further comprises a bipolar transistor connected in series with the Zener diode, and the bipolar transistor has its base and collector connected together.

6. The semiconductor integrated circuit according to claim 1, wherein the reference voltage circuit comprises a plurality of Zener diodes connected in series.

7. The semiconductor integrated circuit according to claim 1, wherein the buffer circuit comprises a load arranged between the emitter/source of the first transistor and the ground line.

8. The semiconductor integrated circuit according to claim 1, wherein the reference power supply further comprises a low-pass filter configured to remove a high-frequency component of the first voltage, and to output the first voltage thus low-pass filtered to the first transistor via its base/gate.

9. The semiconductor integrated circuit according to claim 1, wherein the reference power supply further comprises a first capacitor arranged between the second power supply line and the ground line.

10. The semiconductor integrated circuit according to claim 1, wherein the reference power supply further comprises a second capacitor arranged between the base/gate of the first transistor and the ground line.

11. The semiconductor integrated circuit according to claim 1, wherein the reference power supply includes a resistor instead of the current source.

12. The semiconductor integrated circuit according to claim 1, wherein the first transistor is configured as a bipolar transistor.

13. The semiconductor integrated circuit according to claim 1, wherein the first transistor is configured as a MOSFET (Metal Oxide Semiconductor Field Effect Transistor).

14. The semiconductor integrated circuit according to claim 1, configured to be mounted on a vehicle.
